(19) United States
(12) Patent Application Publication
(10) Pub. No.: US 2022/0026518 A1
(43) Pub. Date: Jan. 27, 2022

(54) SYSTEM FOR LOCALIZATION OF SOUND SOURCES

(71) Applicant: BSS ApS, Odense C (DK)

(72) Inventors: John HALLAM, Odense SV (DK); Jakob CHRISTENSEN-DALSGAARD, Odense M (DK); Danish SHAIKH, Odense C (DK); Mads HELLE, Odense C (DK)

(21) Appl. No.: 17/312,048

(22) PCT Filed: Dec. 12, 2019
(86) PCT No.: PCT/EP2019/084970

§ 371 Date: Jun. 9, 2021

(30) Foreign Application Priority Data
Dec. 17, 2018 (DK) PA 2018 70819

(51) Int. Cl. G01S 5/20; G01S 5/00; G01S 5/22

(52) U.S. Cl. CPC G01S 5/20; G01S 5/22; G01S 5/0081

(57) ABSTRACT

A sound or vibration source localization system with a master unit and a plurality of slave units. The master unit transmit a time synchronization signal via an RF link to the slave units. A microphone or vibration sensor in each of the slave units are used to record a short time sequence, e.g. 0.2-2 seconds, of sound or vibration time aligned with the time synchronization signal to ensure synchronous recording of the time sequences at all slave units. The slave unit transmit the recorded time aligned time sequences via an RF link along with a time stamp and an identification code to the master unit. The master unit has a processor system arranged to process the received time sequences from the slave units according to a lizard ear mimicking algorithm. Such type of algorithm provides a good direction estimate in response to two input signals recorded at different positions, even with a short time sequence. As a result, and preferably along with information regarding physical positions of the slave units, a sound source or vibration source localization estimate can be generated.

### FIELD OF THE INVENTION

The present invention relates to the field of sound and vibration, and to estimation of localization (e.g. direction and/or position) of a sound or vibration source based processing of two captured sound or vibration signals at different positions.

### BACKGROUND OF THE INVENTION

Precise and fast localization of a sound source has a number of applications. Either in a stationary setting, e.g. for incoming emergency vehicles to control traffic lights, detection of incoming Unmaned Aerial Vehicles (UAVs), e.g. drones, or for robotic navigation in response to a voice or other sound sources. Such systems require at least two sound sensors, and preferably for reliable operation and e.g. 3D localization, in general an array of a significant number of sound sensors may be required. Several processing methods exist to process two sound input signals and determining a sound source direction accordingly.

However, for many applications, it is a requirement for practical reasons that the sound sensors involved are wireless. E.g. in case the sound sensors are to be mounted in mobile robots for navigating based on sound. This constitutes a problem, since normal wireless data packet communication suffers from the fact that sound processing involved in localization based on captured sound signals at different positions is sensitive with respect to time matching of the sound signals. If the time matching is unreliable, the sound source direction estimate will in general be useless.

### SUMMARY OF THE INVENTION

Thus, according to the above description, it is an object of the present invention to provide a system and a method for localization of sound sources which can function also with the sound capturing sensors wirelessly connected.

In a first aspect, the invention provides a sound or vibration source localization system comprising

a plurality of slave units each comprising
a Radio Frequency (RF) receiver arranged to receive a time synchronization signal,
a microphone and/or a vibration sensor,
a recording system arranged to store a time sequence of an audio and/or vibration signal captured by the microphone and/or vibration sensor time aligned with the time synchronization signal, and
an RF transmitter arranged to transmit a data packet indicative of the time sequence over an RF link along with a time stamp and an identification code, and

a master unit comprising
an RF transmitter to transmit a time synchronization signals to the plurality of slave units,
an RF receiver arranged to receive data packets indicative of the time sequences from the plurality of slave units via the RF link,
a processor system arranged to process time aligned pairs of received time sequences from the plurality of slave units according to a lizard ear mimicking algorithm, and generating a sound or vibration source direction and/or position estimate in response to an output from said lizard ear mimicking algorithm, preferably along with information regarding physical positions of the at least two slave stations.

Such system is advantageous and solves the mentioned problem, since the combination of using a lizard ear mimicking algorithm and an RF link to transmit a time synchronization signal to slave units has been found to provide a reliable sound source localization. This allows the slave units with sound sensors to be connected wirelessly to the master unit. The lizard ear mimicking algorithm, see e.g. WO 2010/149167 A1, can provide a reliable localization result even with short sound sequences of such as 0.2-2 seconds. This can be transmitted in one data packet via a wireless RF link. Thus, it is possible to provide a time synchronization signal via RF to ensure sufficient time alignment of the slave units, at least within a distance of such as 10 m, to produce time aligned time sequences for successful localization. I.e. at distances at least up to such as 10 m, it can be ensured that the same time signal transmitted to all slave units are received simultaneously or at least within a very narrow time window, at all slave units, thus ensuring time aligned time sequence recordings.

Especially, the principle of lizard ear mimicking algorithms are known to provide a robust for sound around 2-4 kHz, even with a short distance between the two or more microphones. Especially, the lizard ear mimicking algorithm preferably involves a neural algorithm providing a modelling of nervous processing to the two sound signals. Additionally, such nervous system model may contain a neural network that can self-adapt so as to provide an auto-calibration.

The same RF link can be used for transmission, e.g. an RF link based on a carrier frequency of 430-450 MHz. Standard wireless RF transceiver devices can be used.

Such localization system has a number of applications which include robotic applications, i.e. with the slave and/or master unit(s) to be mounted on mobile platforms, as well as surveillance applications with a (high) number of distributed slave units which can be powered by batteries or by electric power grid connection, but without the need for a wired interconnection of slave units and master unit.

It is to be understood that the same system may function to localize vibration sources e.g. with the slave units having an accelerometer to sense a vibration signal.

In the following, preferred features and embodiments of the invention will be described.

An embodiment comprises at least three slave units, e.g. 3-20 slave units, and wherein the direction estimation algorithm is arranged to generate a sound or vibration source direction estimate by applying a combination algorithm to a plurality of outputs from the lizard ear mimicking algorithm in response to respective pair of time aligned time sequences received from different pairs of slave units, such as involving a triangulation algorithm. This allows e.g. 3D localization and/or merely combining several two channel directional estimated into a more reliable localization. E.g. for surveillance of UAVs or other vehicles, several sets of slave units can be distributed with distances of several meters from each other.

The RF link may be based on a carrier frequency within 100 MHz to 1 GHz, such a within 400-500 MHz, preferably within 430-440 Mhz, such as 433 MHz. The transmission may either be airborne or wired, e.g. wired by a power line.

The recording system is arranged to store time sequences having a fixed length of within 0.1-10 seconds, such as 0.2-2 seconds. This has been found to be sufficient time for a lizard ear mimicking algorithm to function reliably, and thus it is possible to ensure good time alignment when only short time sequences are required from the slave units. Further, it is easy to transmit such short time sequences in one single RF transmission packet, thereby allowing quickly repeating localization estimates.

The time synchronization signal and the data packets may be communicated via the same RF link, thus requiring only a simple RF transmitter and receiver module in the master and slave units.

The time synchronization signal may be a periodic signal with a fixed frequency of within 100 Hz to 5 kHz, such as within 300 Hz and 3 kHz. The periodic signal may be a square wave signal, e.g. with a 50% duty cycle, a chirp signal or even a random white noise signal, and wherein the time alignment by the slave unit is performed to a rising or falling edge of the square waves. A random white noise signal has proven to be advantageous in case of environments with a high degree of reflections.

Preferably, the recording system is arranged to store the time sequence with a sample rate being within 10-100 kHz, such as being within 10-30 kHz. This allows sufficient bandwidth for the lizard ear mimicking algorithm to work at least up to 2-4 kHz, e.g. up to such as 16 kHz.

In preferred embodiments, the plurality of slave units comprise a microphone and a recording system arranged to capture and sample an audio signal. In other embodiments, the slave unit have alternatively or additionally each an accelerometer to allow vibration sensing and a recording system arranged to sample a vibration signal.

The RF transmitter and RF receiver of the master unit and the plurality of slave units may be configured for wireless RF transmission, i.e. airborne electromagnetic transmission via an antenna. Alternatively, or additionally, the RF transmitter and RF receiver of the master unit and the plurality of slave units may be configured for wired RF transmission, such as via a power line.

In some embodiments, at least one slave unit is configured to act as a master unit, upon request. This allows a more flexible system, e.g. where several devices e.g. on mobile robots or the like, can act as slave units as well as master units. This allows a system e.g. of mobile robots which can all navigate based on acoustic signals generated by other robots or base on acoustic signals generated by stationary beacons. Likewise, the master unit may be configured to act as a slave unit, upon request.

In an embodiment, the master unit and/or at least one of the slave units are mounted on respective self propelling devices, such as robotic devices, such as autonomous robotic devices. Especially, at least a first self propelling device is arranged to generate an audio signal, i.e. an acoustic signal, so as to allow the sound or vibration localization system of a second self propelling devices to estimate a direction to or a position of the first self propelling device in response to a plurality of slave units receiving the audio signal. Especially, at least one slave unit is arranged to be stationary in such system.

In a second aspect, the invention provides use of the system according to the first aspect for at least one of: navigating self propelling devices by means of sound or vibration, localizing incoming Unmanned Aerial Vehicles (UAVs), localizing emergency vehicles for controlling traffic light, and surveillance and monitoring of mechanical parts in ship, truck and trains, e.g. monitoring rear in ball bearing, bad ignition in one piston or defect in construction etc. Another examples are hearing aids, where the directionality plays an important role in noise filtering, however, it is inconvenient to wire the hearing-aid pairs together since this require a wire around the head of the wearer. Sound and/or vibrations sensors for surveillance beacons in connections with defense and counterterrorism using small satellites to monitoring areas for intrusion of different types of vehicles, e.g. to avoid roadside bombs.

In a third aspect, the invention provides a method for localizing a sound or vibration source, the method comprising

transmitting a time synchronization signal via an RF transmitter from a master unit,

receiving the time synchronization signal by an RF receiver at a plurality of slave units,

capturing a sound and/or vibration signal at the plurality of slave units,

storing at the slave units time sequences of the captured sound and/or vibration signal aligned with the time synchronization signal,

transmitting a data packet indicative of the time sequence over an RF link along with a time stamp and an identification code from the plurality of slave units,

receiving data packets indicative of the time sequences from the plurality of slave units via the RF link,

processing a time aligned pair time sequences received from the plurality of slave units according to a lizard ear mimicking algorithm at the master unit, and

generating a sound or vibration source direction and/or position estimate in response to an output from said lizard ear mimicking algorithm, preferably along with information regarding physical positions of the plurality of slave units.

In a fourth aspect, the invention provides a computer program product having instructions which, when executed on a plurality of slave units with respective processors and a master unit with a processor, cause the slave units and the master unit to perform the method according to the third aspect. Such program product is preferably divided into a part to be executed by the respective slave units and a part to be executed by the master unit.

The mentioned computer program products may be: a program product for a dedicated device, or a stand-alone software product for a general computer. It is to be understood that the computer program product instructions in the form of program code which may be implemented on any processing platform, e.g. a dedicated audio device, a general processor in a computer device, e.g. in the form of a downloadable application for a programmable device.

Especially, the computer program products of the fourth aspect may be stored on a computer readable medium or stored in an electronic chip. E.g. the program code can be implemented in a microprocessor unit, a Digital Signal Processor or a Field-Programmable Gate Array, or it may be provided for downloading on the internet.

It is appreciated that the same advantages and embodiments described for the first aspect apply as well for the second, third, and fourth aspects. Further, it is appreciated that the described embodiments can be intermixed in any way between all the mentioned aspects.

### BRIEF DESCRIPTION OF THE FIGURES

The invention will now be described in more detail with regard to the accompanying figures of which

FIG. 1 illustrates a simple block diagram of a system embodiment, and

FIG. 2 illustrates steps of a method embodiment.

The figures illustrate specific ways of implementing the present invention and are not to be construed as being limiting to other possible embodiments falling within the scope of the attached claim set.

### DETAILED DESCRIPTION OF THE INVENTION

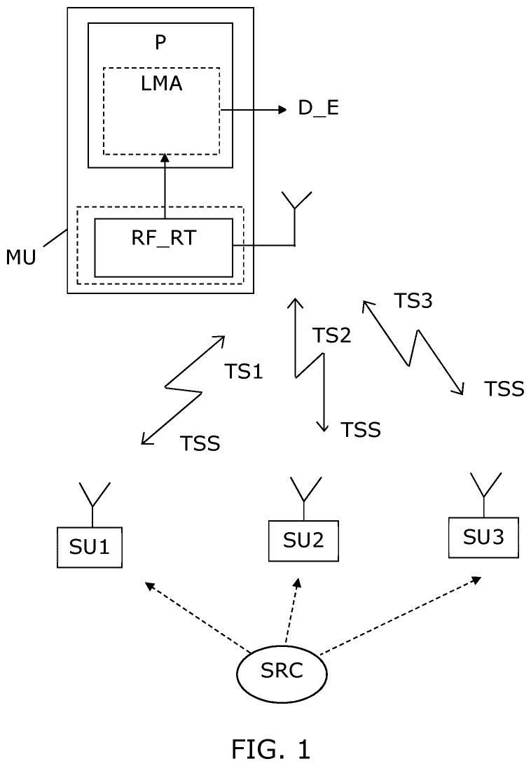

FIG. 1 shows a block diagram illustrating in simple form a sound source localization system embodiment with three slave units SU1, SU2, SU3 positioned at different locations, and a master unit MU. A sound source SRC generates an acoustic signal (dashed lines) which is received by microphones in the three slave units SU1, SU2, SU3. The master unit MU has an RF receiver and and RF transmitter, here shown as on unit RF_RT. The RF transmitter part RF_RT can transmit an airborne wireless RF signal with a time synchronization signal TSS represented therein, e.g. a square wave signal with a frequency between 200 Hz and 2,000 Hz. The RF signal may be transmitted at an RF link with a carrier frequency of e.g. 433 MHz. RF receivers in the slave units SU1, SU2, SU3 receive the time synchronization signal TSS approximately at the same time due to the RF transmission, and this time synchronization signal TSS is then used to set timing of a recording of the acoustic signal from the sound source. Therefore, the resulting time sequences recorded TS1, TS2, TS3 by the respective slave units SU1, SU2, SU3, e.g. having a fixed length of such as 0.2-2 seconds, are in general time aligned. The recorded time sequences TS1, TS2, TS3 are then transmitted in data packets by airborne wireless RF, e.g. at the same RF carrier frequency as the time synchronization signal TSS, e.g. a 433 MHz carrier frequency. Along with the data packets, a time stamp for identifying the time of recording, and an identification code for identifying from which one of the slave units SU1, SU2, SU3 the data packet was sent.

The master unit MU receives the RF transmitted data packets indicative of the time sequences TS1, TS2, TS2 from the plurality of slave units SU1, SU2, SU3, and the time sequences are process by processor P executing a lizard ear mimicking algorithm LMA, see e.g. WO 2010/149167 A1 for details of implementation of such two-channel algorithm utilizing the properties of the lizard ear to obtain a direction estimate which is superior to other direction estimation algorithms. Thus, two by two the three time aligned time sequences TS1, TS2, TS3 are processed by the lizard ear mimicking algorithm LMA to produce partial sound source SRC direction estimates, and by a combination of these partial direction estimates, a resulting direction sound source SRC direction estimate D_E can be achieved. Of course the direction estimate D_E depends on the actual positions of the microphones of the slave units SU1, SU2, SU3 relative to the sound source SRC, and thus preferably the physical positions of the slave units are applied to the master unit MU. This can be predetermined fixed position of the slave units SU1, sU2, SU3, or the slave units SU1, SU2, SU3 may be arranged to transmit in the RF link a position code, e.g. obtained via GPS or via another method, so as to allow the algorithm LMA of the master unit MU to determine the sound source SRC direction estimate D_E based on the actual positions, e.g. also in case the SU1, SU2, SU3 are mobile and thus change positions.

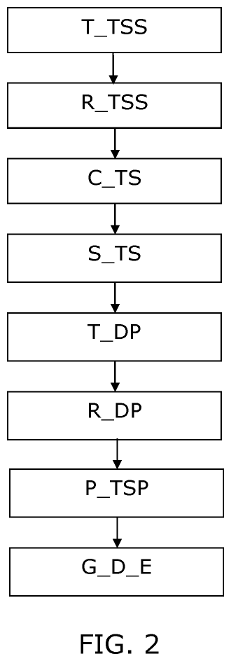

FIG. 2 illustrates steps of a method embodiment a method for localizing a sound source, the method comprising transmitting T_TSS a time synchronization signal via an RF transmitter from a master unit, e.g. a square wave signal with a fixed frequency of within 200 Hz to 3 kHz and transmitted over a wireless RF link at a carrier frequency within 100 MHz to 1 GHz. Next, receiving the time synchronization signal R_TSS by an RF receiver at a plurality of slave units. A sound signal from a sound source is captured C_TS by respective microphones in each of the plurality of slave units. Next, the slave units each store S_TS a time sequence, such as 0.2-2 seconds sampled at a sample rate of 10-100 kHz, time aligned with the time synchronization signal. E.g. this is done by starting a time sequence of a fixed length in synchronization with the synchronization time signal, so as to ensure that all involved slave units obtain sound time sequences from exactly the same periods in time. Next, transmitting a data packet T_DP indicative of the time sequence over a wireless RF link, e.g. at the same RF carrier frequency used for transmission of the time synchronization signal, along with a time stamp and an identification code from the plurality of slave units. The data packets from the plurality of slave units are then received R_DP via the wireless RF link along with the identification code to identify origin of the time sequences and a time stamp, e.g. a sequence number indicating the time where the time sequence was recorded. A pair of time aligned time sequences received from the slave units are then processed P_TSP according to a lizard ear mimicking algorithm at the master unit. Finally, an output from this lizard ear mimicking algorithm is used to generate a sound source direction estimate G_D_E. If sound source position is in addition the goal to archive, predetermined information regarding physical positions of the plurality of slave units which may in addition be received, e.g. transmitted to the master unit from the slave units themselves via the RF link.

It is to be understood that the steps of the method may be repeated at regular intervals to updated sound source direction and/or position estimates.

It is to be understood that the system and method according to the invention can be utilized in a variety of applications where a sound sound or a vibration source location is desired. Especially, the lizard ear mimicking algorithm helps to provide a reliable direction estimate even with a short distance between the slave units and by means of short time sequences.

To sum up, the invention provides a sound or vibration source localization system with a master unit and a plurality of slave units. The master unit transmit a time synchronization signal via an RF link to the slave units. A microphone or vibration sensor in each of the slave units are used to record a short time sequence, e.g. 0.2-2 seconds, of sound or vibration time aligned with the time synchronization signal to ensure synchronous recording of the time sequences at all slave units. The slave unit transmit the recorded time aligned time sequences via an RF link along with a time stamp and an identification code to the master unit. The master unit has a processor system arranged to process the received time sequences from the slave units according to a lizard ear mimicking algorithm. Such type of algorithm provides a good direction estimate in response to two input signals recorded at different positions, even with a short time sequence. As a result, and preferably along with information regarding physical positions of the slave units, a sound source or vibration source localization estimate can be generated.

Although the present invention has been described in connection with the specified embodiments, it should not be construed as being in any way limited to the presented examples. The scope of the present invention is to be interpreted in the light of the accompanying claim set. In the context of the claims, the terms “including” or “includes” do not exclude other possible elements or steps. Also, the mentioning of references such as “a” or “an” etc. should not be construed as excluding a plurality. The use of reference signs in the claims with respect to elements indicated in the figures shall also not be construed as limiting the scope of the invention. Furthermore, individual features mentioned in different claims, may possibly be advantageously combined, and the mentioning of these features in different claims does not exclude that a combination of features is not possible and advantageous.

1. A sound or vibration source localization system, comprising:
a plurality of slave units, each comprising
an RF receiver arranged to receive a time synchronization signal,
a microphone and/or a vibration sensor,
a recording system arranged to store a time sequence of an audio and/or vibration signal captured by the microphone and/or vibration sensor time aligned with the time synchronization signal, and
an RF transmitter arranged to transmit a data packet indicative of the time sequence over an RF link along with a time stamp and an identification codes; and
a master unit comprising
an RF transmitter to transmit a time synchronization signals to the plurality of slave units,
an RF receiver arranged to receive data packets indicative of the time sequences from the plurality of slave units via the RF link,
a processor system arranged to process time aligned pairs of received time sequences from the plurality of slave units according to a lizard ear mimicking algorithm, and generating a sound or vibration source direction and/or position estimate in response to an output from said lizard ear mimicking algorithm, optionally with information regarding physical positions of the at least two slave units.

2. The system according to claim 1, comprising at least three slave units, and being arranged to generate a sound or vibration source direction estimate by applying a combination algorithm to a plurality of outputs from the lizard ear mimicking algorithm in response to respective pair of time aligned time sequences received from different pairs of slave units, optionally involving a triangulation algorithm.

3. The system according to claim 1, wherein the RF link is based on a carrier frequency within 100 MHz to 1 GHz.

4. The system according to claim 1, wherein the recording system is arranged to store time sequences having a fixed length of within 0.1-10 seconds.

5. The system according to claim 1, wherein the time synchronization signal and the data packets are communicated via the same RF link.

6. The system according to claim 1, wherein the time synchronization signal has a fixed frequency of within 100 Hz to 5 kHz.

7. The system according to claim 1, wherein the recording system is arranged to store the time sequence with a sample rate being within 10-100 kHz.

8. The system according to claim 1, wherein the plurality of slave units comprise a microphone and a recording system arranged to capture and sample an audio signal.

9. The system according to claim 1, wherein the RF transmitter and RF receiver of the master unit and of the plurality of slave units are configured for wireless RF transmission.

10. The system according to claim 1, wherein the RF transmitter and RF receiver of the master unit and the plurality of slave units are configured for wired RF transmission.

11. The system according to claim 1, wherein at least one slave unit is configured to act as a master unit, upon request.

12. The system according to claim 1, wherein the master unit is configured to act as a slave unit, upon request.

13. The system according to claim 1, wherein the master unit and/or at least one of the slave units are mounted on respective self propelling devices.

14. The system according to claim 13, wherein at least a first self propelling device is arranged to generate an audio signal, so as to allow the sound or vibration localization system of a second self propelling devices to estimate a direction to or a position of the first self propelling device in response to a plurality of slave units receiving the audio signal.

15. The system according to claim 13, wherein at least one slave unit is arranged to be stationary.

16. Use of the system according to claim 1 for at least one of: navigating self propelling devices by means of sound or vibration, localizing incoming Unmanned Aerial Vehicles, localizing emergency vehicles for controlling traffic light, surveillance and monitoring of mechanical parts in a truck or a train or a ship, monitoring wear in a ball bearing, monitoring bad ignition in one piston or defect in construction, hearing aids, and sound and/or vibrations sensors for surveillance beacons in connections with defense.

17. A method for localizing a sound or vibration source, the method comprising
transmitting a time synchronization signal via an RF transmitter from a master unit,
receiving the time synchronization signal by an RF receiver at a plurality of slave units,
capturing a sound and/or vibration signal at the plurality of slave units,
storing at the slave units time sequences of the captured sound and/or vibration signal aligned with the time synchronization signal,
transmitting a data packet indicative of the time sequence over an RF link along with a time stamp and an identification code from the plurality of slave units,
receiving data packets indicative of the time sequences from the plurality of slave units via the RF link,
processing a time aligned pair time sequences received from the plurality of slave units according to a lizard ear mimicking algorithm at the master unit, and
generating a sound or vibration source direction and/or position estimate in response to an output from said lizard ear mimicking algorithm, preferably along with information regarding physical positions of the plurality of slave units.

18. A computer program product having instructions which, when executed on a plurality of slave units with respective processors and a master unit with a processor, cause the slave units and the master unit to perform the method according to claim 17.
